(19) United States
(12) Patent Application Publication
(10) Pub. No.: US 2009/0284028 A1
(43) Pub. Date: Nov. 19, 2009

(54) Manipulation Lever Assembly for Trunk Lids

(75) Inventor: Sang Kyu OH, Namyangju-si (KR)

Correspondence Address: MORGAN, LEWIS & BOCKIUS LLP (SF), One Market, Spear Street Tower, Suite 2800, San Francisco, CA, 94105, US

(73) Assignee: HYUNDAI MOTOR COMPANY, Seoul (KR)

(21) Appl. No.: 12/323,311

(22) Filed: Nov. 25, 2008

(30) Foreign Application Priority Data
May 16, 2008 (KR) 10-2008-0045322

(51) Int. Cl. B62D 25/12

(52) U.S. Cl. 292/336.3

(57) ABSTRACT

A manipulation lever assembly for a trunk lid may include a manipulation lever including a connection portion wherein the connection portion is pivotally coupled to the trunk lid; and an actuation member, one end portion of which is coupled to a first end portion of the manipulation lever and the other end portion of which is coupled to a locking assembly of the trunk lid, wherein when the locking assembly is unlocked, the actuation member activates the manipulation lever, so that a second end of the manipulation lever is extracted outwards from the trunk lid.

### CROSS-REFERENCE TO RELATED APPLICATIONS

The present application claims priority to Korean Patent Application No. 10-2008-0045322 filed May 16, 2008, the entire contents of which application is incorporated herein for all purposes by this reference.

### BACKGROUND OF THE INVENTION

1. Field of the Invention

The present invention relates to a manipulation lever assembly for trunk lids.

2. Description of Related Art

Generally, trunks which can be openably closed by lids and which are for loading cargo are provided in the rear ends of vehicles.

As shown in FIG. 5, in a conventional technique, a locking device 11 is provided in a trunk lid 10 and is constructed such that a user can release the locked state of the trunk lid 10. A garnish 12 is attached to the trunk lid 10 above a license plate attachment area 13 to improve the external appearance. The locking device 11 includes a locking assembly, which is installed in the trunk lid 10, and a key slot which is exposed outside of the trunk lid 10, so that when a private key is inserted into the key slot and rotated, the locking assembly is operated in conjunction with the rotation of the private key. Therefore, when the user inserts the private key into the key slot and rotates it, the trunk lid is released from the vehicle body.

However, when it is desired to close the trunk lid after loading cargo into the trunk, the user usually places his/her hand on the outer panel of the trunk lid and pushes the trunk lid downwards. This operation inconveniences the user.

In particular if the trunk lid is exposed to the outside for a long time, the outer panel of the trunk lid becomes covered with foreign substances, such as dust or dirt. In this state, if the user contacts the outer panel of the trunk lid, the hand of the user becomes stained with the foreign substances, thus making the user feel unpleasant.

The information disclosed in this Background of the Invention section is only for enhancement of understanding of the general background of the invention and should not be taken as an acknowledgement or any form of suggestion that his information forms the prior art already known to a person skilled in the art.

### BRIEF SUMMARY OF THE INVENTION

Various aspects of the present invention are directed to provide for a manipulation lever assembly for trunk lids which is constructed such that when a trunk lid is unlocked, a manipulation lever is extracted outwards from the trunk lid, so that a user can open or close the trunk lid using the manipulation lever without contacting the trunk lid, thus preventing the hand of the user from being strained or coming into contact with the foreign substances.

In an aspect of the present invention, a manipulation lever assembly for a trunk lid may include a manipulation lever including a connection portion, wherein the connection portion is pivotally coupled to the trunk lid, and/or an actuation member, one end portion of which is coupled to a first end portion of the manipulation lever and the other end portion of which is coupled to a locking assembly of the trunk lid, wherein when the locking assembly is unlocked, the actuation member activates the manipulation lever, so that a second end of the manipulation lever is extracted outwards from the trunk lid.

The one end portion of the actuation member may be coupled to a front side at the first end portion of the manipulation lever and the connection portion may be formed at a rear side of the manipulation lever.

a housing may be mounted in a depression of the trunk lid and the connection portion of the manipulation lever is pivotally coupled to the housing.

The depression of the trunk lid may include an upper depression formed above a license plate attachment area disposed on a rear surface of the trunk lid.

The actuation member may include an actuation cable.

The actuation member may include at least a link.

The manipulation lever assembly may further include an elastic member coupling the connection portion of the manipulation lever to the trunk lid and biasing the manipulation lever to original position with respect to the connection portion. The elastic member may be a rubber.

The manipulation lever assembly may further include a returning spring coupled at respective opposite ends thereof to the trunk lid and the manipulation lever, the returning spring biasing the extracted manipulation lever toward an original position of the manipulation lever with respect to tie connection portion.

The return spring may be a torsion spring.

The returning spring may include a first spring portion disposed at the connection portion of the manipulation lever, and/or a second spring portion coupled to the manipulation lever except for the connection portion, the second spring portion being connected to the first spring portion.

A hinge shaft may penetrate the connection portion and pivotally connect the manipulation lever with the trunk lid therethrough.

A removal prevention piece may be provided on an end of the hinge shaft to prevent the manipulation lever from being released from the hinge shaft.

The manipulation lever assembly may further include a stopper protruding from the trunk lid, so that the extracted manipulation lever is locked to the stopper and maintains the extracted state.

The stopper may be disposed between the connection portion and the second end portion of the manipulation lever in a normal state.

The stopper may have an inclined portion, which is inclined in a direction in which the manipulation lever is extracted outwards from the trunk lid.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a bottom perspective view of an exemplary manipulation lever assembly for trunk lids according to the present invention.

FIG. 2 is a bottom perspective view showing an extracted state of a lever of the manipulation lever assembly of FIG. 1.

FIG. 3 is an enlarged perspective view showing the extracted state of the manipulation lever of FIG. 2.

FIG. 4 is a view showing an exemplary process of returning the manipulation lever, which has been in the extracted state, to its original position according to the present invention.

FIG. 5 is a view showing a trunk lid of a vehicle according to a conventional technique.

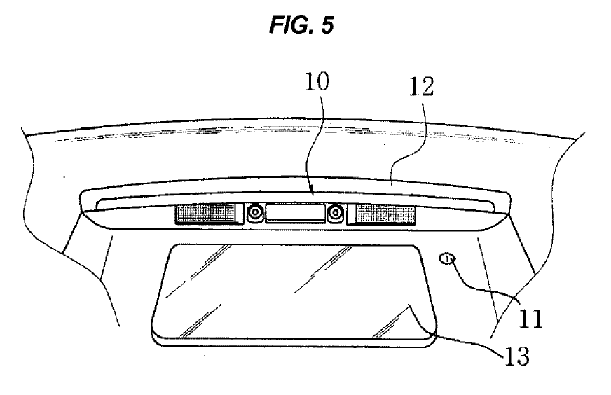

### DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

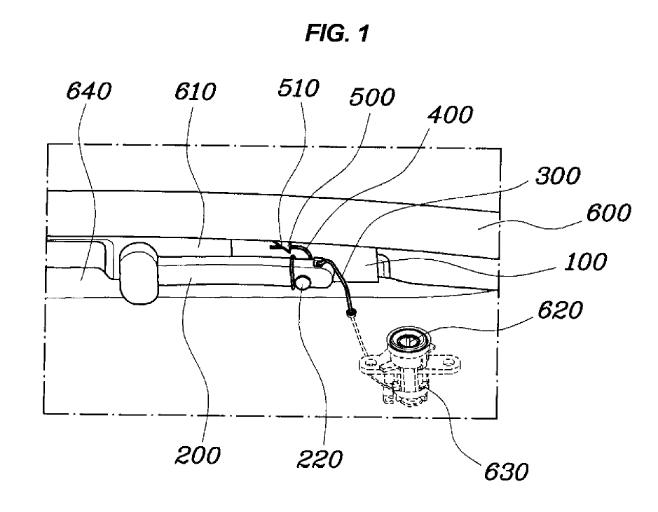

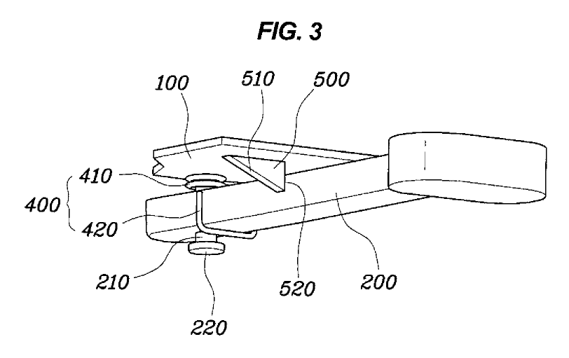

As shown in FIGS. 1 through 3, a manipulation lever assembly for trunk lids according to various embodiments of the present invention is constructed such that when a trunk lid 600 is unlocked from a vehicle body, a manipulation lever 200 extracts itself from the trunk lid 600. Hence, the present invention enables a user to hold the manipulation lever 200 using his/her hand and open or close the trunk lid 600 without contacting an outer panel of the trunk lid 600.

The configuration, as various embodiments of the present invention, will be described in detail below. The manipulation lever assembly includes a housing 100 and the manipulation lever 200, which is hinged to the housing 100. The housing 100 is mounted in a depression, which is formed in the trunk lid 600, so that the housing 100 is not exposed to the outside of the trunk lid 600. The term “depression” means an upper depression 610, which is formed above a license plate attachment area 640 disposed on the rear surface of the trunk lid 600.

The manipulation lever 200 is rotatably coupled to the housing 100 by a hinge shaft 210. In detail, the manipulation lever 200 has a bar shape, and is coupled at a first end thereof to the hinge shaft 210 such that a second end thereof is rotatable around the hinge shaft 210.

Therefore, after the second end of the manipulation lever 200 is rotated and extracted from the trunk lid 600, the user can hold the second end of the manipulation lever 200 and push or pull it in one direction to open or close the trunk. Then, the trunk lid 600 can be easily opened or closed.

In other words, the manipulation lever 200 is configured such that when the trunk lid 600 is unlocked, the manipulation lever 200 extracts itself from the trunk lid 600.

For this, an actuation cable 300 is connected to the first end of the manipulation lever 200. The actuation cable 300 is connected to the locking assembly 630 installed in the trunk lid 600, such that the actuation cable 300 is operated in conjunction with the locking assembly 630.

In various embodiments of the present invention, the actuation cable 300 may be coupled to a front side of the manipulation lever 200 and a portion at rear side of the manipulation lever 200 may be coupled to the trunk lid 600 so that the manipulation lever 200 can be received in the narrow depression of the trunk lid 600.

Therefore, when a private key is inserted into a key slot 620 of the locking assembly 630 and is rotated in one direction, the trunk lid 600 is unlocked and, simultaneously, a rotor of the locking assembly 630 pulls the actuation cable 300. Then, the actuation cable 300 pulls the first end of the manipulation lever 200 by the pulling operation of the rotor, so that the second end of the manipulation lever 200 is extracted outwards from the upper depression 610 of the trunk lid 600.

In various embodiments, although the actuation cable 300 has been illustrated as being used as a means for connecting the manipulation lever 200 to the locking assembly 630, the present invention is not limited to this, and various kinds of connecting means can be used.

For example, the manipulation lever 200 may be connected to the locking assembly 630 using a link structure. Furthermore, the actuation cable 300 need not be connected to the rotor of the locking assembly 630, and the actuation cable 300 may be connected to an actuation member, such as a latch of the trunk lid 600, such that when the trunk lid 600 is unlocked, the manipulation lever 200 can be pulled by the actuation cable 300 in conjunction with the latch.

The manipulation lever 200, which has been rotated and extracted outwards from the trunk lid 600 by the unlocking operation of the locking assembly 630, can be returned to its original position by a returning spring 400.

In various embodiments of the present invention, the returning spring 400 is fastened at a first end thereof to the housing 100 and is fastened at a second end thereof to the manipulation lever 200. Thus, the manipulation lever 200, which has been extracted outwards, can be returned to its original position by the elastic force of the returning spring 400.

Here, the operation of returning the manipulation lever 200 to its original position using the returning spring 400 can be restrained by a stopper 500.

The stopper 500 protrudes from the housing 100 such that the manipulation lever 200, which is rotated in the direction in which it is retracted, is stopped by the stopper 500. In detail, the stopper 500 has an inclined portion 510, which is inclined upwards in the direction in which the manipulation lever 200 is extracted outwards, and a stop portion 520, which is abruptly slanted from the end of the inclined portion 510.

Therefore, when the manipulation lever 200 is rotated by the unlocking operation of the locking assembly 630, the second end of the manipulation lever 200 passes over the inclined portion 510 and then is locked to the stop portion 520. Thus, the extracted state of the manipulation lever 200 can be maintained.

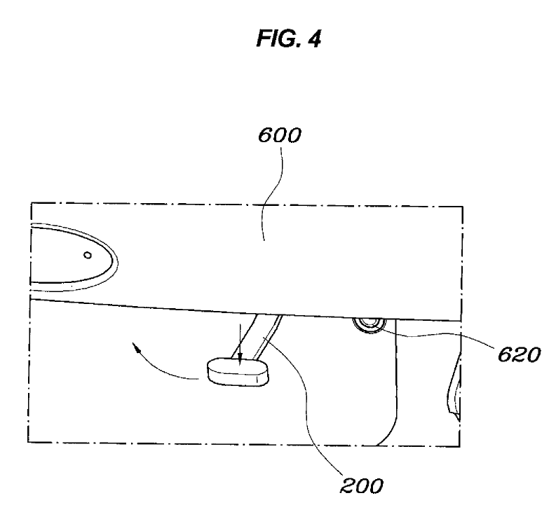

As shown in FIG. 4, the manipulation lever 200, which has been locked to the stop portion 520, can be retracted to its original position by pulling the manipulation lever 200 downwards, that is, in the direction parallel to the hinge shaft 210.

To achieve this purpose, the returning spring 400 includes a first spring portion 410, which is wound around the hinge shaft 210, and a second spring portion 420, which is connected to the first spring portion 410 and is wound around the manipulation lever 200. The second spring portion 420 is offset from the hinge shaft 210 with a predetermined distance to give a rotational moment to the manipulation lever 200 with respect to the hinge shaft 210.

The first spring portion 410 provides rotational elastic force to the manipulation lever 200 such that when the manipulation lever 200 is extracted outwards from the trunk lid 600, the manipulation lever 200 is biased towards the original position.

The second spring portion 420 provides upward elastic restoring force to the manipulation lever 200 such that when the manipulation lever 200 is pulled in the direction parallel to the hinge shaft 210 downwards, the manipulation lever 200 is biased upwards towards its original position.

Therefore, when the manipulation lever 200, which has been locked to the stop portion 520, is pulled downwards in the direction parallel to the hinge shaft 210, the manipulation lever 200 passes over the stop portion 520 of the stopper 500, then the manipulation lever 200 is returned by the elastic force of the returning spring 400 to the original position thereof.

Here, a removal prevention piece 220 is provided on the end of the hinge shaft 210. The removable prevention piece 220 functions to prevent the manipulation lever 200 from being removed from the hinge shaft 210 when the manipulation lever 200 is pulled downwards in the direction parallel to the hinge shaft 210.

In various embodiments of the present invention, one may appreciate that the return spring 400 can be replaced by a single body of a rubber since the rubber is elastic in three dimensions.

In further embodiments of the present invention, one may appreciate that the return spring 400, the hinge shaft 210 and the removable prevention piece 220 can be replaced by a single body of a rubber since the rubber is elastic in three dimensions as set forth above.

The operation and effect of the present invention having the above-mentioned configuration will be explained herein below.

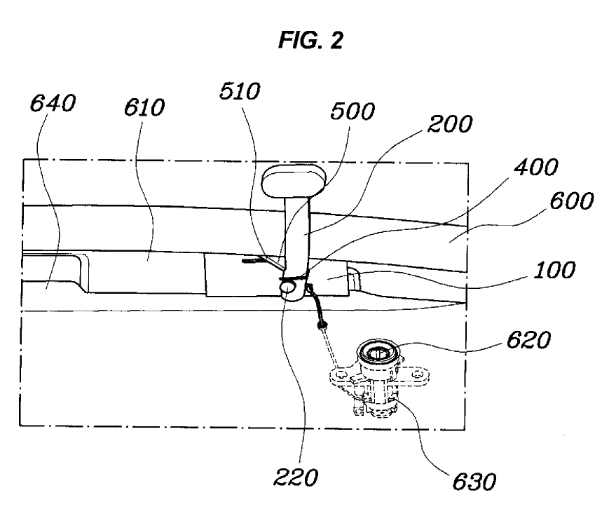

From the state of FIG. 1 in which the manipulation lever 200 is disposed inside the upper depression 610 of the trunk lid 600, when the private key is inserted into the key slot 620 of the locking assembly 630 and is rotated, the rotor of the locking assembly 630 pulls the actuation cable 300, as shown in FIG. 2.

Thus, the first end of the manipulation lever 200 is pulled by the rotor. Therefore, the second end of the manipulation lever 200 is rotated outwards and thus becomes extracted from the upper depression 610 of the trunk lid 600.

Where, while the manipulation lever 200 is rotated outwards, the second end of the manipulation lever 200 passes over the inclined portion 510 of the stopper 500 and is thereafter locked to the stop portion 520. Thereby, the manipulation lever 200 can be maintained in the extracted state. Then, the user can open or close the trunk lid 600 using the extracted manipulation lever 200.

Thereafter, as shown in FIG. 4, when the user pulls downwards the manipulation lever 200, which has been locked to the stop portion 520, that is, in the direction parallel to the hinge shaft 210 beyond the length of the stop portion 520, the manipulation lever 200 passes over the stop portion 520 of the stopper 500 and then is returned to its original position by the elastic force of the returning spring 400.

As described above, the present invention provides a manipulation lever assembly for trunk lids which is constructed such that when a trunk lid is unlocked, a manipulation lever becomes extracted outwards from the trunk lid, so that a user can conveniently open or close the trunk lid using the manipulation lever without contacting the trunk lid. Particularly, when the trunk lid is closed, because the user can close the trunk lid using the manipulation lever, the hand of the user can be prevented from being strained with foreign substances which cover the outer panel of the trunk lid.

For convenience in explanation and accurate definition in the appended claims, the terms, “upper”, “upwards”, “downwards”, “front”, and “rear” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention as well as various alternatives and modifications thereof. It is intended that the scope of the invention be defined by the claims appended hereto and their equivalents.

What is claimed is:

1. A manipulation lever assembly for a trunk lid, comprising:
a manipulation lever including a connection portion, wherein the connection portion is pivotally coupled to the trunk lid; and
an actuation member, one end portion of which is coupled to a first end portion of the manipulation lever and the other end portion of which is coupled to a locking assembly of the trunk lid, wherein when the locking assembly is unlocked, the actuation member activates the manipulation lever, so that a second end of the manipulation lever is extracted outwards from the trunk lid.

2. The manipulation lever assembly as set forth in claim 1, the one end portion of the actuation member is coupled to a front side at the first end portion of the manipulation lever and the connection portion is formed at a rear side of the manipulation lever.

3. The manipulation lever assembly as set forth in claim 1, a housing is mounted in a depression of the trunk lid and the connection portion of the manipulation lever is pivotally coupled to the housing.

4. The manipulation lever assembly as set forth in claim 3, wherein the depression of the trunk lid comprises an upper depression formed above a license plate attachment area disposed on a rear surface of the trunk lid.

5. The manipulation lever assembly as set forth in claim 1, the actuation member includes an actuation cable.

6. The manipulation lever assembly as set forth in claim 1, the actuation member includes at least a link.

7. The manipulation lever assembly as set forth in claim 1, further comprising an elastic member coupling the connection portion of the manipulation lever to the trunk lid and biasing the manipulation lever to original position with respect to the connection portion.

8. The manipulation lever assembly as set forth in claim 7, wherein the elastic member is a rubber.

9. The manipulation lever assembly as set forth in claim 1, further comprising:
a returning spring coupled at respective opposite ends thereof to the trunk lid and the manipulation lever, the returning spring biasing the extracted manipulation lever toward an original position of the manipulation lever with respect to the connection portion.

10. The manipulation lever assembly as set forth in claim 9, the return spring is a torsion spring.

11. The manipulation lever assembly as set forth in claim 9, wherein the returning spring comprises:
a first spring portion disposed at the connection portion of the manipulation lever; and
a second spring portion coupled to the manipulation lever except for the connection portion, the second spring portion being connected to the first spring portion.

12. The manipulation lever assembly as set forth in claim 9, wherein a hinge shaft penetrates the connection portion and pivotally connecting the manipulation lever with the trunk lid therethrough.

13. The manipulation lever assembly as set forth in claim 12, wherein a removal prevention piece is provided on an end of the hinge shaft to prevent the manipulation lever from being released from the hinge shaft.

14. The manipulation lever assembly as set forth in claim 1, further comprising:
a stopper protruding from the trunk lid, so that the extracted manipulation lever is locked to the stopper and maintains the extracted state.

15. The manipulation lever assembly as set forth in claim 14, wherein the stopper is disposed between the connection portion and the second end portion of the manipulation lever in a normal state.

16. The manipulation lever assembly as set forth in claim 14, wherein the stopper has an inclined portion, which is inclined in a direction in which the manipulation lever is extracted outwards from the bunk lid.

17. A passenger vehicle comprising the manipulation lever assembly as set forth in claim 1.
